(19) United States
(12) Patent Application Publication
(10) Pub. No.: US 2013/0282598 A1
(43) Pub. Date: Oct. 24, 2013

(54) PATENT ASSESSMENT SYSTEM AND METHOD

(71) Applicants: Yue Ma, Princeton Jct, NJ (US); Jingbo Zhu, Shenyang (CN)

(72) Inventors: Yue Ma, Princeton Jct, NJ (US); Jingbo Zhu, Shenyang (CN)

(21) Appl. No.: 13/857,676

(22) Filed: Apr. 5, 2013

Related U.S. Application Data
(60) Provisional application No. 61/635,896, filed on Apr. 20, 2012.

(51) Int. Cl. G06Q 50/18; G06Q 10/00

(52) U.S. Cl. CPC G06Q 50/184; G06Q 10/00
USPC 705/310

(57) ABSTRACT

The present invention discloses a system and method for assessing a granted patent, comprising a locater for locating from a patent record database a patent history record corresponding to the granted patent, a comparator for identifying from the patent history record one or more prosecution changes occurred to an original patent application of the granted patent and an analyzer for producing a patent assessment report based on said one or more prosecution changes. Visualization tools may be provided to view the patent assessment results.

### CROSS-REFERENCE TO RELATED APPLICATIONS

This application claims the benefit of U.S. Provisional Application Ser. No. 61/635,896, filed on Apr. 20, 2012. The disclosure of the above application is incorporated herein by reference in its entirety for any purpose.

### FIELD OF THE INVENTION

The present invention generally relates to patent analytics, and particularly relates to system and method for assessing patent quality.

### BACKGROUND OF THE INVENTION

Patent analytics uses computer technologies and software algorithms to evaluate a patent with respect to its quality both qualitatively and quantitatively. A well designed patent analytics system generates a patent assessment report that is as close as a human expert would using heuristics, know-how's and related intelligent information. Such patent assessment report may help a professional to evaluate a patent for the purpose of variety of tasks such as patent filing, patent prosecution, patent sales, patent licensing, patent landscape, patent strategy and patent related business decisions. In addition, a computer based patent analytics system also assesses patent quality in an reasonably objective manner combining real world information, empirical data or other information from heterogeneous data sources to produce realistic and meaningful assessment. The present invention attempts to achieve this goal.

### SUMMARY OF THE INVENTION

A patent assessment system according to one aspect of the present invention comprises a patent history locator, a document comparator, a key term analyzer, and a patent analyzer. Patent history locator is to locate related patent record and data for a given granted patent. For example, when the system or user locates a granted patent for assessment, patent history locator may find the original patent application corresponding to the granted patent, patent family (i.e. patents originated from the same or overlapped inventors on same or similar inventions), foreign counterparts (i.e. patents filed in a foreign country based on the same invention from the same inventor), patent prosecution history (e.g. documents communicated to/from between the Patent Office and the applicant, claim amendment, office action, patent search report, information disclosure statement etc.), or other related information. Document comparator compares the patent for assessment with its related patent documents located by patent history locator and find differences (such as text added to or deleted from the original claim etc.) and correlation between the two, to be used as one or more factors in patent assessment. Patent key term analyzer extracts key terms in a given patent document. Patent analyzer analyzes a given patent combining information and data from other functional modules or information sources. Depending on the specific task, the output of patent analyzer can be at least one of the metrics used in patent evaluation such as patent citation information, patent enforcement information, patent technical strength, applicable market to the patent, the scope of patent claims, the claim breadth, claim diversity, and the strength of a patent with respect to the integrity of the specification etc.

The present invention is advantageous in combining rich information external and pertinent to a patent under assessment thus giving a more accurate and meaningful assessment of the patent.

For a more thorough understanding of the invention, its objectives and advantages refer to the following specification and to the accompanying drawings.

### BRIEF DESCRIPTION OF THE DRAWINGS

The present invention will become more fully understood from the detailed description and the accompanying drawings, wherein:

FIG. 1 is an exemplary functional description of a patent assessment system according to one aspect of the present invention.

FIG. 2 shows an example of claim comparison according to one aspect of the present invention.

FIG. 3 shows another example of claim comparison according to one aspect of the present invention.

FIG. 4 is an example claim showing the key terms extracted according to one aspect of the present invention.

FIG. 5 is an exemplary functional description of a patent key term analyzer according to one aspect of the present invention.

FIG. 6 is an exemplary functional description of key term analyzer according to one aspect of the present invention.

### DETAILED DESCRIPTION OF THE PREFERRED EMBODIMENTS

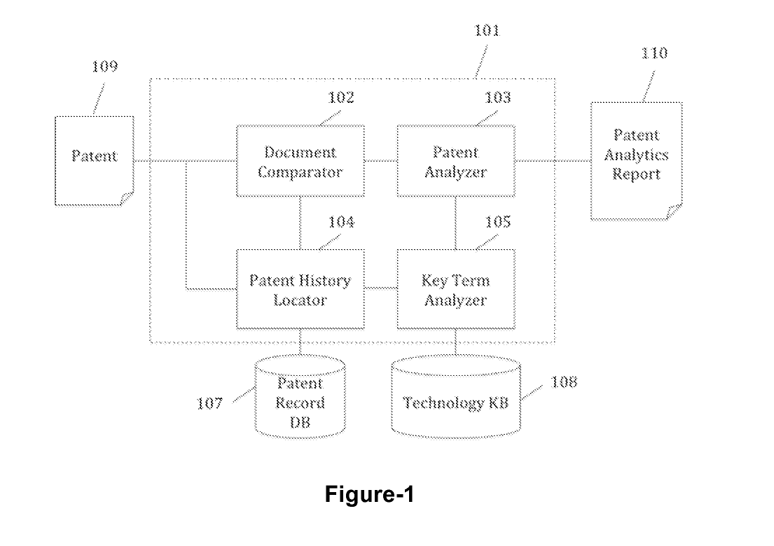

With reference to FIG. 1, a patent assessment system 101 according to one aspect of the present invention comprises a patent history locator 104, a document comparator 102, a key term analyzer 105, and a patent analyzer 103.

Patent History Locator 104 is to locate related patent record and data for a given patent. For example, when the system or user locates a granted patent for assessment 109, Patent History Locator 104 may find the original patent application corresponding to the granted patent 109, patent family (i.e. patents originated from the same or overlapped inventors on same or similar inventions), foreign counterparts (i.e. patents filed in a foreign county based on the same invention from the same inventor), patent prosecution history (e.g. documents communicated to/from between the Patent Office and the applicant, claim amendment, office action, patent search report, information disclosure statement etc.), or other related information.

Document Comparator 102 compares the patent for assessment 109 with its related patent documents located by Patent History Locator 104 and find differences (such as text added to or deleted from the original claim etc.) and correlation between the two.

Patent Key Term Analyzer 105 extracts key terms in a given patent document.

Patent Analyzer 103 analyzes a patent combining information and data from other functional modules or information sources. Depending on the specific task, the output of patent analyzer can be at least one of the metrics used in patent evaluation such as patent citation information, patent enforcement information, patent technical strength, applicable market to the patent, the scope of patent claims, the claim breadth, claim diversity, and the strength of a patent with respect to the integrity of the specification etc.

### I. Exemplary Embodiment

An exemplary scenario is provided below to further illustrate various components of the present inventive system. However, it is by no means indicative of limiting the scope of the present invention. By way of example and with reference to FIG. 1, a granted patent 109 under evaluation is located and fed into the present inventive system 101 for assessment. Patent History Locator 104 first locates the corresponding original patent application to said granted patent, and the corresponding claims in the original application. The Document Comparator 102 then compares the two documents by associating a claim in the granted patent 109 with its associating claim in the original application, then find the history of claim changes from original application to its corresponding granted counterpart claim by claim. As known to an expert in patent evaluation and/or patent valuation, patent claim amendment history is a good way to interpret a patent claim and its scope.

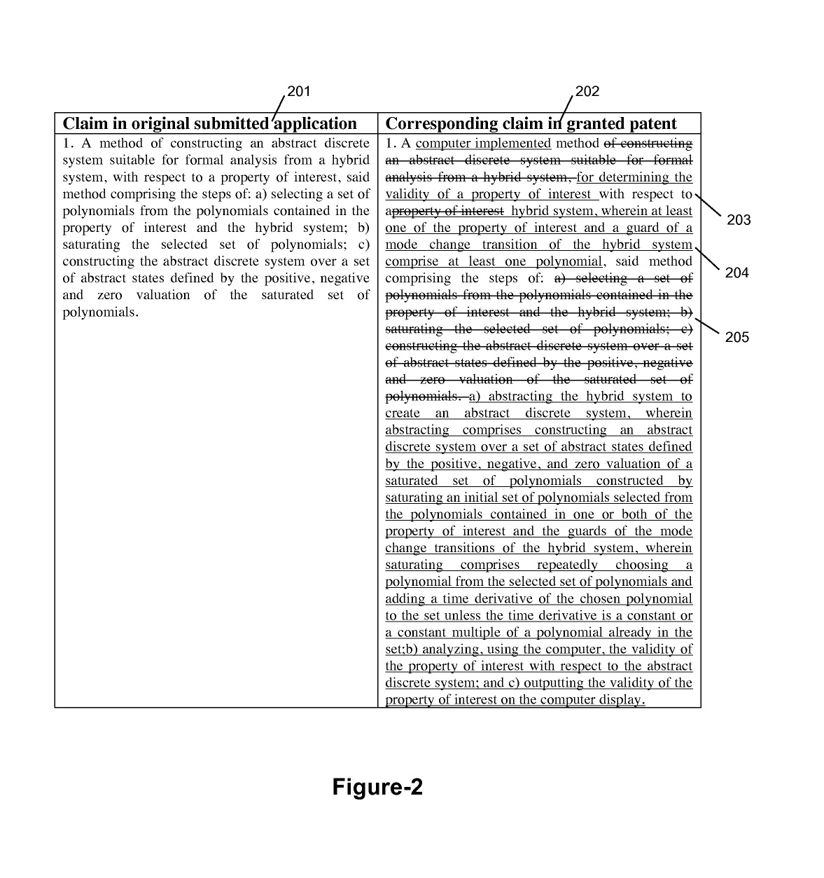

FIG. 2 shows an example of claim amendment history. The original claim (as submitted the application) 201 is shown in the left column, its corresponding granted claim 202, together with the changes, is shown in the right column. As shown, “strike out” text 205 stands for those deleted, underlined text 204 stands for those added text in the prosecution process, and unchanged text 203 stands for those appeared in the original claim 201.

With reference to FIG. 1, once the claim amendment history is generated or located, Patent Analyzer 103 generates various assessment metrics of a patent. For example, based on claim amendment history, a patent claim breadth indicator can be generated. Table 1 lists exemplary formulas for generating various patent assessment metrics.

TABLE 1
Patent Quality Metrics

| Patent quality | |
|---|---|
| metrics | Formulas |
| Claim diversity | = a * N + b * n, |
| | where N is the # of independent claims, n is the # of |
| | different types of claims (e.g. method, system/ |
| | apparatus, means + function claims etc.), a and b |
| | are empirical constants. The higher the value, the |
| | better the claim diversity. |
| Claim breadth | = min (a * Wi + b * Ci/Wi), |
| | i: {all independent claims} |
| | where Wi is the # of words in ith independent claim, |
| | Ci is the cost of claim amendment to be generated |
| | from the document comparator, to be explained |
| | below, a and b are empirical constants. The lower |
| | the value, the better the claim breadth. |
| Claim integrity | = Max (a * Ri + b * Yi), |
| | i: {all independent claims} |
| | where Ri is the # of unique key term words in the ith |
| | independent claim that do not appear in the spec, Yi |
| | is the # of unique key term words in the ith |
| | independent claim that appear in the spec only once. |
| | The extraction of key term words will be explained |
| | below, a and b are empirical constants. The lower |
| | the value, the better the claim integrity. |

### II. Document Comparator

An exemplary way to build a document comparator is to locate the text for target document and original document and compare the two strings. To achieve this, one way is to use well-known edit distance, also called Levenshtein distance. It is generally used to compute the similarity of two strings via three basic actions: insert, delete and replace. As an example, s and t denote source string and target string, we define the distance between two strings s[0 . . . n] and t[0 . . . m] as d[m, n], where m, n are the lengths of string t and s, respectively.

TABLE 2
Calculation of edit distance.

| Step | Description |
|---|---|
| 1 | Set n to be the length of s. |
| | Set m to be the length of t. |
| | If m = 0, return m and exit. |
| | If n = 0, return n and exit. |
| | Construct a matrix containing 0..m rows and 0..n columns. |
| 2 | Initialize the first row to 0..n. |
| | Initialize the first column to 0..m. |
| 3 | Examine each character of s (i from 1 to m). |
| 4 | Examine each character of t (j from 1 to n). |
| 5 | If s[i] equals to t[j], the cost is 0. |
| | If s[i] does not equal to t[j], the cost is 1. |
| 6 | Set cell d[i, j] of the matrix equal to the minimum of: |
| | a. The cell immediately above plus 1: d[i − 1, j] + 1. |
| | b. The cell immediately to the left plus 1: d[i, j − 1] + 1. |
| | c. The cell diagonally above and to the left plus the cost: |
| | d[i − 1, j − 1] + cost. |
| 7 | After the iteration steps (3, 4, 5, 6) are complete, the distance is |
| | found in cell d[m, n]. |

As an example, Table 3 shows how the edit distance is computed when the source string is “GUMBO” and the target string is “GAMBOL”. From the table, we can see the distance between source string and destination string is 2.The shortest path is labeled underlined in the table.

TABLE 3
An example of edit distance calculation.

| | | G | U | M | B | O |
|---|---|---|---|---|---|---|
| | 0 | 1 | 2 | 3 | 4 | 5 |
| G | 1 | 0 | 1 | 2 | 3 | 4 |
| A | 2 | 1 | 1 | 2 | 3 | 4 |
| M | 3 | 2 | 2 | 1 | 2 | 3 |
| B | 4 | 3 | 3 | 2 | 1 | 2 |
| O | 5 | 4 | 4 | 3 | 2 | 1 |
| L | 6 | 5 | 5 | 4 | 3 | 2 |

According to one aspect of the present invention, we calculate the cost of claim amendment by first associating a claim from the original patent application file to its corresponding claim from the published granted patent file, and treating the original claim and granted claim as source and target strings, respectively. We then compute edit distance. We first create a two dimensions array d[m, n] where n and m are the length of source string and target string, respectively. The matrix can be initialized and calculated as shown in the following pseudo code

```
for i: 0 to m d[i,0]=i,; for j:0 to n d[0,j]=j;
  for i:1 to m
    for j:1 to n
      d[i,j]=min(d[i−1,j−1]+cost, d[i−1,j]+1,d[j,j−1]+1);
```

According to one aspect of the present invention, we set the cost of insert and delete operation to 1. Accordingly, cost=0, if s[i]=t[j], otherwise cost=1. The cost can be set to other values without limiting the scope of the present invention.

In order to mark inserted and deleted string, we need to back trace to find the shortest path at each step and save the corresponding operation and string contents, then merge the result. An example is shown in FIG. 2 to compare a claim in original patent application and the claim in its corresponding granted patent. Here, the strike out 205 is deleted text from the original claim, the underlined 204 is added text to the granted claim during patent prosecution, and the non-marked text 203 is unchanged.

Generally, the more changes (insert or delete) there are in the claim amendment, the more limitations the new claim may have. Consequently, a claim amendment cost can be assigned to reflect the claim breadth as shown in Table 1. By way of example, the claim amendment cost can be calculated based only on the number of inserted letters, or deleted letters, or a combination thereof, for example, by a weighted sum.

According to another aspect of the present invention, a claim text can be segmented into words or phrases. Consequently, a cost can be assigned based on the length of the word or phrases. For example, the cost for adding “word” would be 4, the cost for adding “field” would be 5 etc.

According to another aspect of the invention, the cost for different operations can be different, and the cost for different length of text segment can be nonlinear. A training system can be designed to derive optimal set of costs.

Variations of Document Comparator can be implemented. According to one aspect of the present invention, instead of comparing source and target text strings, the Document Comparator can directly look for claim amendment in the patent prosecution history. The patent prosecution history can be directly text searchable (e.g. searchable PDF), or if not, can be converted to searchable text via optical character recognition (OCR) techniques. Then the Document Comparator can search for claim amendment in each of applicant's response to Office action.

According to another aspect of the present invention, for the purpose of patent assessment, Document Comparator can also look for other information that changes between any two Office actions during the prosecution of a patent. For example, the reason for rejection in each Office action can be located and analyzed, and patent assessment result can be based on a number of factors, such as the number of §101, §102, §103, and §112 sixth paragraph issues etc. that are pertaining to U.S. Patent Law (or the corresponding issues in patent law of other countries), the number of references the Examiner cited in each rejection, the number of new references the Examiner used in rejecting the same claim as previous Office rejection etc. The higher the number of references an Examiner cited in an Office rejection, the more crowded prior arts are around the claim of concern. Similarly, the higher the number of new references an Examiner used in rejecting the same claim as previous Office rejection, the stronger the rejection may be - this reflects an Examiner's high belief that a claim sought is not patentable.

### III. Key Term Analyzer

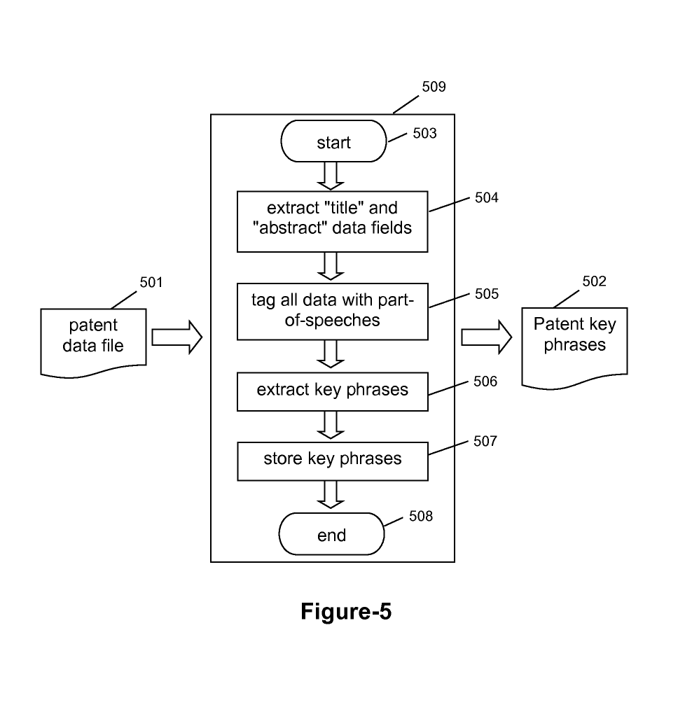

The Key Term Analyzer identifies essential terminologies or key terms from one or more parts of a patent, such as topic, abstract, specification and/or patent claims. As described above, these essential terminologies can be used in other process of the system, for example, in Patent Analyzer, to be described later. The Key Term Analyzer employs common natural linguistic processing techniques incorporating POS (Part of Speech) tagging and keyword extraction. In one embodiment of the present invention, topic and abstract sections of a patent are used to extract essential terminologies or key terms. With reference to FIG. 5, an exemplary key term extraction system 509 is described. For each patent, the system firstly extracts its “title” and “abstract” data fields (step 504) to form a raw text. Secondly, in step 505, it adopts a POS tagger to assign part-of-speeches to every word in the raw text. There are several POS tagger systems available in the public domain, such as “Feature-Rich Part-of-Speech Tagging with a Cyclic Dependency Network” by Kristina Toutanova, Dan Klein, Christopher Manning, and Yoram Singer, in Proceedings of HLT-NAACL 2003, pages 252-259. Thirdly, the system uses a key phrase extraction core algorithm 506 to identify key phrases for the text. Optionally, it stores the key phrases of every patent document in a file for later use, as shown in 507.

The part-of-speech of a word in a key phrase can be any one element in the set of all part-of-speeches, i.e. noun, verb, adjective etc. Examples of POS that can be extracted are illustrated in Table 4.

TABLE 4
Examples of POS elements.

| POS Element | Description |
|---|---|
| NN | Noun, singular or mass |
| VB | Verb, base form |
| JJ | Adjective |
| VBZ | Verb, 3rd person singular present |
| RB | Adverb |
| VBN | Verb, past participle |
| TO | To |
| NNP | Proper noun, singular |
| NNS | Noun, plural |

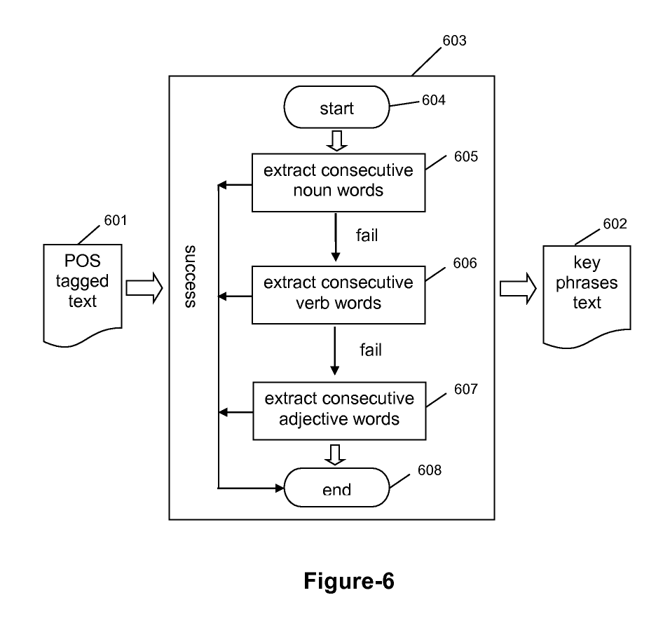

According to one aspect of the present invention, we assume that nouns, verbs and adjectives much more commonly appear in a key phrase. Thus we chose consecutive nouns (NN), consecutive verbs (VB) or consecutive adjectives (JJ) as possible values of part-of-speeches of the words in a key phrase. With reference to FIG. 6, when given a text with tagged part-of-speeches, the key phrase extraction algorithm 603 will firstly extract consecutive noun words as key phrases in 605. If this step succeeds, the algorithm will stop; else it will try to extract consecutive verb words as key phrases in 606. If this step succeeds, the algorithm stops; else it will try to extract consecutive adjective words as key phrases in 607. Whether this step succeeds or fails, the algorithm will stop. If there exists extracted key phrases, the algorithm returns the key terms. For example, given the tagged text as below, “operating_NNsystem_NNis_VBZparticularly_RBwell_RBsuited_VBNto_TO ROM_NNPbased_VBNmobile_JJcomputing_NNdevices_NNS ._.”Then three key phrases will be extracted “operating system *ROM *computing devices”, where “*” is an end mark of a key phrase.

While we make our assumption that key phrases are more likely to be words comprising of consecutive noun, verb or adjective word classes, variations should not depart from the spirit of the present invention. For example, in another embodiment of the present invention, we could extract key words comprising of more than one word class such as “heuristic_JJrule_NN”, “liquid_NNemitting_JJdisplay_VV” using the similar framework as shown in FIG. 6.

In another embodiment of the present invention, key terms can be extracted incorporating statistic approaches such as TF-IDF (term frequency-inverse document frequency), mutual information, entropy, etc. For example, TF-IDF is calculated based on term frequency and inverted document frequency to determine the importance of a term. If the TF-IDF value of a term is very high, it will be extracted as a key term.

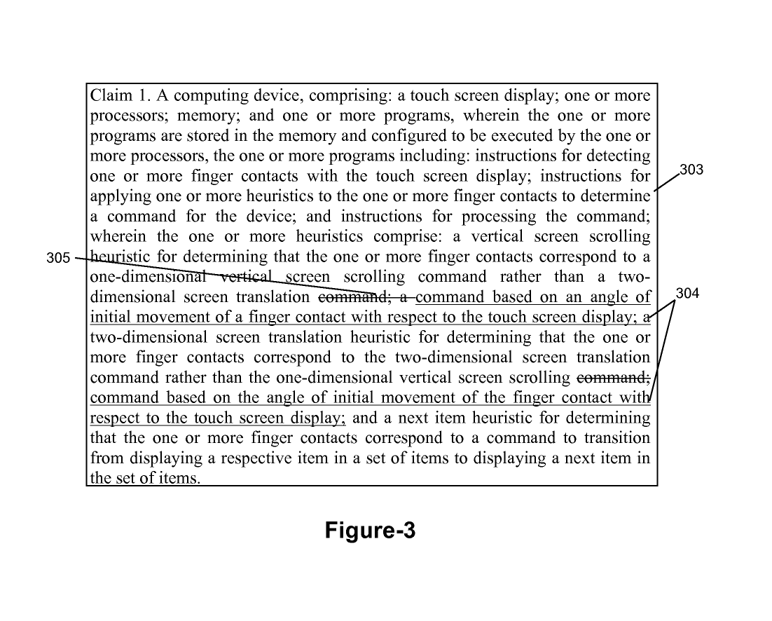

According to another aspect of the present invention, additional features of keyword extraction are based on “phrases” that appear in the patent specification frequently, excluding stop words. For example, “initial movement” or “initial movement of finger” in FIG. 3 are highly likely extracted if they appear in the specification frequently.

According to another aspect of the present invention, the features for keyword extraction are based on “legal” key terms especially those transitional words or limiting language in a patent claim. For example, the word “consisting”, “consists”, “consist”, “comprising”, “whereby” etc. are frequently used patent claim languages. Text that correlates to those terms is particularly interesting (for claim construction and interpretation purpose) and can contribute more influence or weight to the keyword extraction.

### IV. Patent Analyzer

A patent analyzer generates patent assessment metrics. According to one aspect of the present invention, a patent analyzer could generate a patent claim breadth indicator. The result of claim breadth indicator can be integrated into an overall assessment of patent as one assessment factor, or by way of identifying essential claim language in the claim that should prompt the user for more scrutiny. In one embodiment of the present invention, the claim breadth indicator can be based on one or more metrics as below.

(1) New text added in claim amendment. For example, all or part of added text in Document Comparator can be highlighted to alert the user of potential claim limitation in a patent under evaluation. In the example as shown in FIG. 3, the text “command based on an angle of initial movement of a finger contact with respect to the touch screen display;” (304) can be identified (e.g. highlighted, or extracted and isolated, or displayed in different font or color) to the user to indicate that new limiting languages were added.

(2) The number of changes (added or deleted text) in the claim amendment. For example, a counter is initialized to zero. When any text is deleted, the counter increments by a predefined number of a dynamically changing number (for example, based on the length of deleted text). This indicator reflects the extent of claim amendment or significance of changes in the claim in relative to the original claim, and can be used to calculate claim breadth as shown in Table 1.

In another embodiment of the present invention, the essential terminologies or key phrases or key terms extracted can have several uses in a patent analytics task. According to one aspect of the present invention, key phrases extracted from every patent can be merged together to keep only unique key phrases, or grouped to provide a summarization on the patent being analyzed, or summarization of a particular claim of interest.

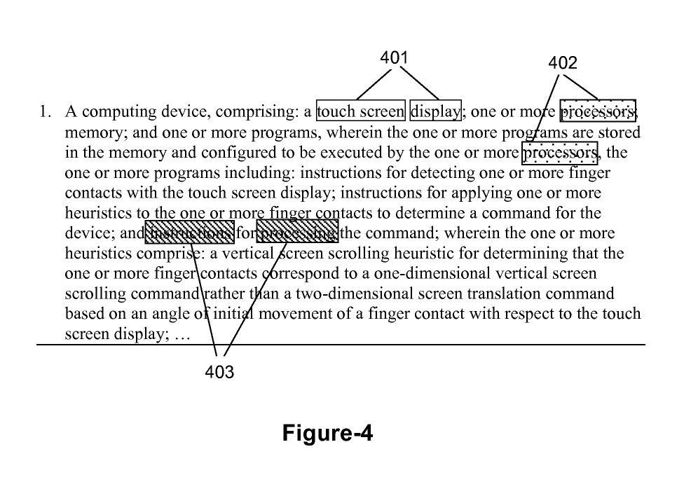

In another embodiment of the present invention, the Key Term Analyzer for a patent claim could also be used as identifying “enabling” elements of a claim and comparing these elements with the specification to make sure they are described and supported in the specification. With reference to FIG. 4, once key terms are identified by Key Term Analyzer, they are checked against the specification of the patent to make sure they are “supported” by the specification of the patent. In this example, different shades or symbols can be used to display key terms that have different frequencies of appearance in the specification, as shown by areas 401, 402 and 403 to indicate frequent appearance in the spec (e.g. more than twice), very few appearance in the spec (e.g. one time), and no appearance in the spec, respectively.

Further variations of checking “enabling” elements could employ approximate matching (if two words are of the same meaning but do not exactly match, e.g. one is singular form and the other is plural form) or spelling correction (if there are spelling errors in the spec or claim due to typo or errors as result of document scanning or OCR error) etc. Approximate matching can employ well known natural language processing techniques for example, stemming the words then comparing, or using edit distance in comparing two strings of text, or using ontology and thesaurus to find words in similar meanings.

According to another aspect of the present invention, key phrases can be used to assess the integrity of claim, as described in Table 1. As an example, key phrases are identified from the claim section and checked against the specification of the patent. While a claim needs to have support in the specification, presumably each key phrase in the claim could find its counterpart in the specification. We count the occurrence in the specification for each identified key phrase in the claim. With reference to Table 1, these occurrences of key phrases in the claim are used to calculate claim integrity.

According to another aspect of the present invention, key terms extracted from Key Term Analyzer could also have an impact on the claim breadth indicator as described in Table 1. For example, if the changed text (between claim in the original application and claim in the granted patent) involves key terms, a heavier penalty will be posted on the indicator, whereas a changed text that does not include key terms will incur lighter penalty or no penalty on the claim breadth indicator.

According to another aspect of the present invention, changed text from claim amendment history can be further examined. For example, if a word “comprise” in a claim is substituted for “consist”, a penalty can be added to the claim breadth indicator because the terminologies “comprise” and “consist” are essential in construing the scope of a patent claim in such a way that “consist” dramatically limits the scope of the claim. Yet in another example, if the changes had involved introducing new essential technical term, such as “heuristic” in the example in FIG. 3, a higher penalty may be assigned in comparison to cosmetic changes such as “;” to “,”, for which a lower or zero penalty could be assigned to the calculation of claim breadth indicator.

### V. Other Embodiments and Variations

The description here is not intended to limit the scope of the invention. Extensions that can be inferred, comprehended and understood by an ordinary in the art are not exhaustive. For example, the system and method as described in the present invention requires a computing device with a microprocessor to execute a computer command. The computing device requires a memory and I/O device (such as a display, printer, USB port, Serial/parallel or internet wired or wireless) in order to present the patent assessment results to a user. Similarly, a report generator is also needed in order to show the assessment results to a user.

Further, when various components are needed, relevant databases may be utilized. Key Term Analyzer may function purely based on the patent under evaluation itself or may incorporate additional information from other databases (DB) or knowledge bases (KB). For example, Key Term Analyzer may use the information in the patent and find related information in the technology knowledgebase (e.g. a published paper from the same inventor on the same invention, where key words are explicitly listed) and use that related information to guide the key term extraction. This can be implemented by assigning new features or giving more favorable weights in extracting keywords.

Still further, some common knowledge key terms in a specific field can be used to build a custom made stop word bank in Key Term Analyzer. The field of the invention can firstly be identified from the patent classification (e.g. U.S. Class or WIPO class) assigned to each patent. For example, a patent may belong to computer architecture from its patent classification, in which the terms “CPU”, “memory”, “storage” etc. are not needed to explicitly explain in the specification of a patent before an ordinary skilled in the art could understand the scope and meaning of these terms. Consequently, once these terms are identified, they can be removed from the Key Term Analyzer result or assigned lighter weight in assessing the claim breadth or integrity.

Still further, according to another aspect of the present invention, key terms can be extracted not only from title and/or abstract, but other parts of the patent document, e.g. the specification, the description of drawings, the claims etc. Still further, the output from Patent Analyzer can be based on the duration of the prosecution (i.e. how long it takes the patent to be granted from its filing date), the number of Office actions occurred during the prosecution period of the patent, the number of unique references used in all Office action rejections, and the average number of references used in each Office action rejection, as one of the criteria in patent assessment.

Still further, the components of the patent assessment can be arranged differently than that in FIG. 1, or the corresponding methods to each component can be arranged in a different sequence within the scope of the present invention. For example, the Key Term Analyzer can perform directly on a patent document independently from the Document Comparator. In another example, the Patent Analyzer can perform independently from and without the Key Term Analyzer. As illustrated previously, key terms may or may not be used in the patent assessment system and method. Still further, different components or methods can be combined into one, or one component or method can be split in multiple subcomponents or steps. Still further, systems and methods described herein can be implemented on a server computer, or a client desktop or mobile device, using one single CPU. In another embodiment of the present invention, patent assessment system is implemented in a client/server environment, while some components are implemented on a server and some on a client computer. Still further, the systems and methods described herein can be implemented in a cloud computing environment using multiple computing resources and storage devices.

Still further, various functional components can be built in a feedback network in order to derive optimal parameters for each component. For example, the result from patent claim breadth indicator in Patent Analyzer can be fed back to Key Term Analyzer to fine tune the keyword extraction, or be fed back to Document Comparator to fine tune the edit distance costs.

Still further variations, including combinations and/or alternative implementations, of the embodiments described herein can be readily obtained by one skilled in the art without burdensome and/or undue experimentation. Such variations are not to be regarded as a departure from the spirit and scope of the invention.

What is claimed is:

1. A method used for assessing a granted patent using a computer, comprising:
locating from a patent record database a patent history record corresponding to the granted patent;
identifying from the patent history record one or more prosecution changes occurred to an original patent application of the granted patent, wherein the prosecution change includes at least one claim amendment; and
using a computer to produce a patent assessment report based on said one or more prosecution changes.

2. The method of claim 1, wherein the step of identifying the claim amendment comprises a step of associating a first claim in the granted patent to a second claim in the original patent application of the granted patent using edit distance.

3. The method of claim 2, wherein the step of producing the assessment report is based on at least one of a number of inserted, a number of deleted and a number of unchanged text strings in the first claim relative to the second claim.

4. The method of claim 1, further comprising the steps of:
extracting one or more key terms from the granted patent;
whereby the step of producing the assessment report is based on one or more extracted key terms.

5. The method of claim 4, wherein the extracting step comprises tagging part-of-the-speech for each text string in the granted patent and extracting one or more key terms whose part-of-the-speech tags are arranged in a predetermined pattern.

6. The method of claim 4, wherein the extracting step comprises calculating frequencies of each word appearing in the granted patent and extracting one or more extracted key terms having the frequency above a predetermined number.

7. The method of claim 1, wherein the prosecution change further includes a number of patentability issues raised by Examiner in one or more rejections.

8. The method of claim 1, wherein the prosecution change further includes a number of references used by Examiner in one or more rejections.

9. The method of claim 1, wherein the prosecution change further includes a number of Office actions occurred to the granted patent.

10. The method of claim 1, wherein the prosecution change further includes an average number of references used in each Office action occurred to the granted patent.

11. A system for assessing a granted patent, comprising:
a locater operative to locate from a patent record database a patent history record corresponding to the granted patent, wherein the patent record database containing a plurality of patent history records;
a comparator operative to identify from the patent history record one or more prosecution changes occurred to an original patent application of the granted patent, wherein the prosecution change includes at least one claim amendment, and the comparator is configured to identify the claim amendment by associating a first claim in the granted patent to a second claim in the original patent application of the granted patent using edit distance;
an analyzer for producing a patent assessment report based on said one or more prosecution changes.

12. The system of claim 11, wherein the analyzer is configured to use at least one of a number of inserted, a number of deleted and a number of unchanged text strings in the first claim relative to the second claim.

13. The system of claim 11, further comprising:
an extractor operative to (i) tag part-of-the-speech for each text string in the granted patent and identify a first set of key terms whose part-of-the-speech tags are arranged in a predetermined pattern; (ii) calculate frequencies of the first set of key terms appearing in the granted patent; and (iii) remove from the first set of key terms one or more key terms having the frequency below a predetermined number to produce a second set of extracted key terms;
whereby the analyzer is configured to produce the assessment report based on the second set of extracted key terms.

14. The system of claim 11, wherein the prosecution change further includes at least one of (i) a number of patentability issues raised by Examiner in one or more rejections; (ii) a number of references used by Examiner in one or more rejections; (iii) a number of Office actions occurred to the granted patent; and (iv) an average number of references used in each Office action occurred to the granted patent.

15. A non-transitory storage media containing instructions for assessing a granted patent, comprising:
instructions for locating from a patent record database a patent history record corresponding to the granted patent;
instructions for identifying from the patent history record one or more prosecution changes occurred to an original patent application of the granted patent, wherein the prosecution change includes at least one claim amendment; and
instructions for producing a patent assessment report based on said one or more prosecution changes.

16. The non-transitory storage media of claim 15, wherein the instructions for identifying the claim amendment are arranged to associate a first claim in the granted patent to a second claim in the original patent application of the granted patent using edit distance.

17. The non-transitory storage media of claim 16, wherein the instructions for producing the assessment report are arranged to use at least one of a number of inserted, a number of deleted and a number of unchanged text strings in the first claim relative to the second claim.

18. The non-transitory storage media of claim 15, further comprising:
instructions for extracting one or more key terms from the granted patent;
whereby the instructions for producing the assessment report are configured to use one or more extracted key terms.

19. The non-transitory storage media of claim 18, wherein the instructions for extracting key terms are configured to tag part-of-the-speech for each text string in the granted patent and extract one or more key terms whose part-of-the-speech tags are arranged in a predetermined pattern.

20. The non-transitory storage media of claim 15, wherein the prosecution change further includes at least one of (i) a number of patentability issues raised by Examiner in one or more rejections; and (ii) a number of references used by Examiner in one or more rejections.
